(19) United States
(12) Patent Application Publication
(10) Pub. No.: US 2003/0025978 A1
(43) Pub. Date: Feb. 6, 2003

(54) Panel display assembly

(76) Inventors: Tzung Yung Yang, Taipei (TW); Chuang Yen Wu, Taipei Hsien (TW); Qing Zhen Li, Taipei Hsien (TW); Wen-Hao Chou, Hsi Chin City (TW)

Correspondence Address: RABIN & BERDO, P.C., Suite 500, 1101 14 th Street, N.W., Washington, DC, 20005, US

(21) Appl. No.: 09/917,817

(22) Filed: Jul. 31, 2001

(51) Int. Cl. G02F 1/03; G02F 1/07; G02B 27/14; G02B 17/00

(52) U.S. Cl. 359/263; 359/631

(57) ABSTRACT

A panel display assembly comprises an interface, a display panel, a backlight and a stage. The interface is electrically connected to the display panel and the backlight. The stage contains a lens to magnify the image projecting from the display panel, a reflecting mirror with 45° to the lens to reflect vertically an image from the lens, an eye lens atop the reflecting mirror to magnify an image from the reflecting mirror, and a viewfinder atop the eye lens from which a user can view an image from the eye lens.

### FIELD OF THE INVENTION

The present invention relates to a panel display assembly, especially to a panel display assembly with light weight and compact size.

### BACKGROUND OF THE INVENTION

The prior art panel display assembly with image-capturing camera is generally erective type. As shown in FIGS. 1 and 2, the erective panel display assembly comprises a stage 60 containing an aspherical lens 65 and an eye lens 70, and a display panel 75.

The above-mentioned panel display assembly is useful to a searcher or a fireman in a foggy or dark place. However, the distance between the aspherical lens 65 and the display panel 75 is generally 17.09 mm; the between the aspherical lens 65 and the eye lens 70 is at least 5.74. The overall size of the panel display assembly is large and the field of view is limited

### SUMMARY OF THE INVENTION

It is the object of the present invention to provide a panel display assembly with light weight, compact size, low cost and comfort to user.

To achieve above object, the present invention provides a panel display assembly having an interface, a display panel, a backlight and a stage. The interface is electrically connected to the display panel and the backlight. The stage contains a lens to magnify the image projecting from the display panel, a reflecting mirror with 45° to the lens to reflect vertically an image from the lens, an eye lens atop the reflecting mirror to magnify an image from the reflecting mirror, and a viewfinder atop the eye lens from which a user can view an image from the eye lens.

The various objects and advantages of the present invention will be more readily understood from the following detailed description when read in conjunction with the appended drawing, in which:

### BRIEF DESCRIPTION OF DRAWINGS

FIG. 1 shows a schematic diagram of a prior art erective panel display assembly;

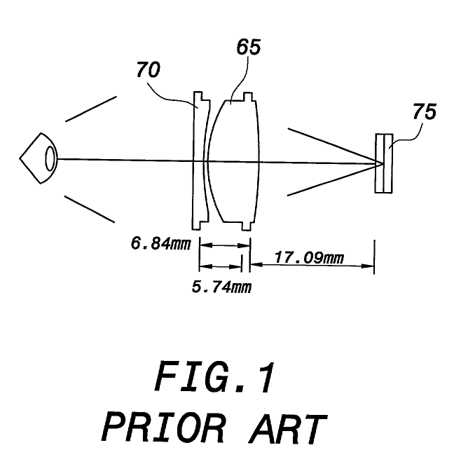

FIG. 2 shows an exploded view of FIG. 1;

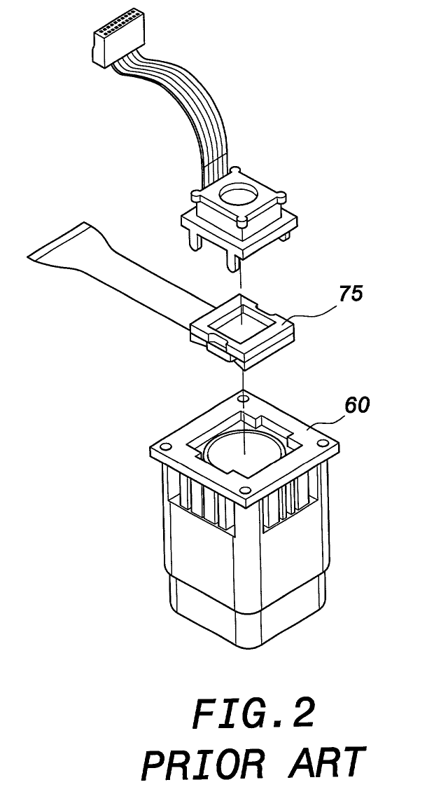

FIG. 3 shows a schematic diagram of a panel display assembly of the present invention;

FIG. 4 shows a block diagram of a panel display assembly of the present invention;

FIG. 5 shows a practical application of the present invention.

### DETAILED DESCRIPTION OF THE INVENTION

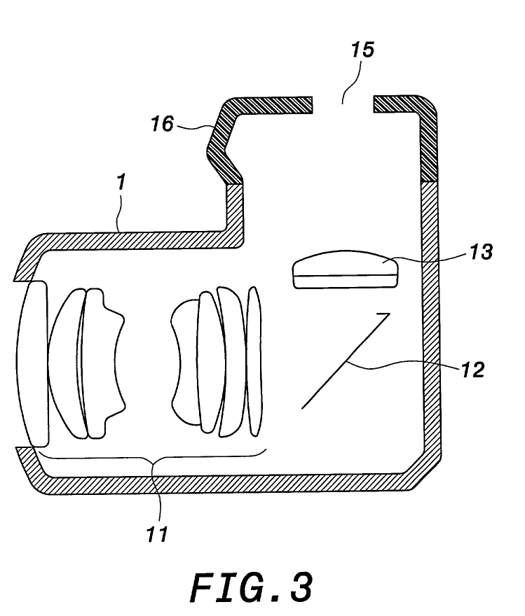

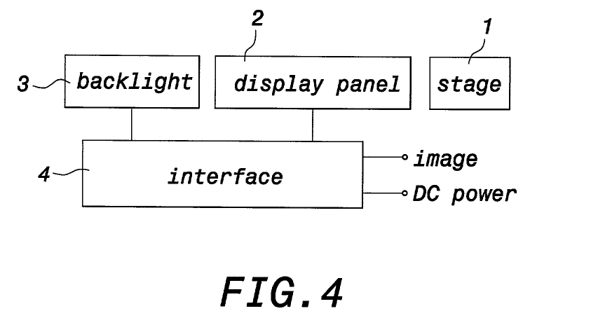

With reference now to FIGS. 3 and 4, the present invention provides a panel display assembly, which comprises an L-shaped stage 1, a display panel 2, a backlight 3 and an interface 4.

The interface 4 is electrically connected to the display panel 2 and the backlight 3, and provide DC power to the display panel 2 and the backlight 3. Moreover, the interface 4 provides an image input function.

The backlight 3 provides a backlight for the display panel 2.

The L-shaped stage 1 contains a lens 11 used to magnify an image from the display panel 2 by 10-30 times. A reflecting mirror 12 is arranged with 45° to the lens 11 and reflects vertically the light from the lens 11. An eye lens 13 is arranged atop the reflecting mirror 12 to magnify an image from the reflecting mirror 12 by 2-3 times. A viewfinder 15 is provided atop the eye lens 13 by which the user can view the image from the eye lens 13. A flexible protective bushing 16 is arranged around the viewfinder 15 to shield light.

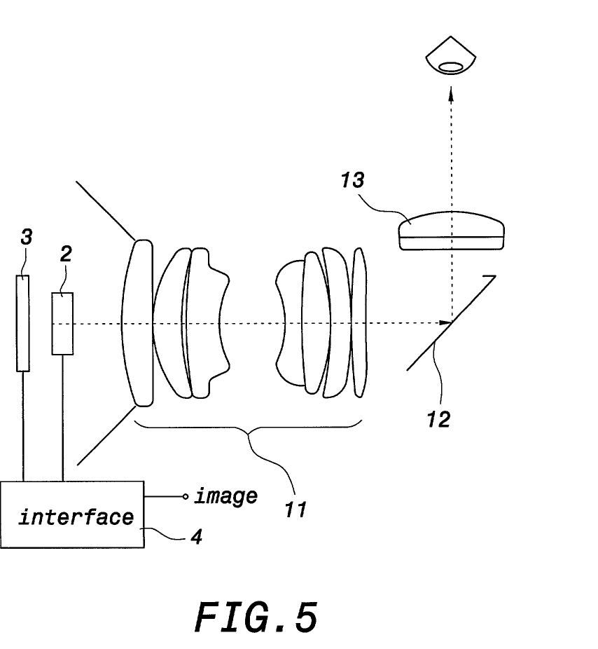

FIG. 5 shows a practical application of the present invention. The ray trace to the viewfinder 15 comes from the display panel 2 and through the lens 11, the reflecting mirror 12 and the eye lens 13, The image is magnified by the lens 11 and the eye lens 13.

To sum up, the panel display assembly of the present invention has following advantages:

(1) Light weight

(2) Compact size

(3) Low cost and practical

(4) Comfortable for user

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

1. A panel display assembly comprising
an interface for inputting DC power and an image;
a display panel electrically connected to the interface and used to display the image input by the interface;
a backlight electrically connected to the interface and used to provide backlight to the display panel;
a stage containing a lens to magnify the image projecting from the display panel, a reflecting mirror with 45° to the lens to reflect vertically an image from the lens, an eye lens atop the reflecting mirror to magnify an image from the reflecting mirror, and a viewfinder atop the eye lens from which a user can view an image from the eye lens.

2. The panel display assembly as in claim 1, wherein the lens is used to magnify an image from the display panel by 10-30 times.

3. The panel display assembly as in claim 1, wherein the eye lens is used to magnify an image from the reflecting mirror by 2-3 times.

4. The panel display assembly as in claim 1, wherein a flexible protective bushing is arranged around the viewfinder to shield light.
